(19) United States
(12) Patent Application Publication
(10) Pub. No.: US 2005/0005746 A1
(43) Pub. Date: Jan. 13, 2005

(54) Method for preparing three-dimensional signs

(76) Inventor: Randolph M. Linenberger, Golden, CO (US)

Correspondence Address: MERCHANT & GOULD PC, P.O. BOX 2903, MINNEAPOLIS, MN, 55402-0903, US

(21) Appl. No.: 10/815,876

(22) Filed: Mar. 31, 2004

Related U.S. Application Data
(63) Continuation-in-part of application No. 09/844,954, filed on Apr. 26, 2001, now abandoned.
(60) Provisional application No. 60/459,680, filed on Mar. 31, 2003.
(60) Provisional application No. 60/199,933, filed on Apr. 26, 2000.

(51) Int. Cl. B26D 3/00; G09F 13/04

(52) U.S. Cl. 83/39

(57) ABSTRACT

An improved method of preparing an intermediate for the return of a channel letter wherein the intermediate is cut from the same sheet stock as the back and face of the letter using a router, which removes material along the edge of the return and along the width of the return indicating the direction and shape that the finished return will take and removing material from the edge and width of the intermediate to facilitate the shaping and bending of the intermediate into its finished configuration.

This application claims the benefit of provisional patent application Ser. No. 60/459,680, filed Mar. 31, 2003. This application also claims priority, as a continuation-in-part application, from U.S. patent application Ser. No. 09/844,954 filed Apr. 26, 2001, incorporated by reference herein, which claims priority from provisional patent application Ser. No. 60/199,933 filed Apr. 26, 2000.

### I. FIELD OF THE INVENTION

The present invention is directed to the manufacture of channel letters. More specifically it relates to a method for more fully automating the manufacture of channel letters using a minimal amount of specialized equipment. It also includes the preparation of improved side walls, i.e., “returns,” for use in preparing such letters.

### II. BACKGROUND OF THE INVENTION

Signs for outdoor advertising on stores, buildings and other applications are frequently prepared by making and mounting three-dimensional graphical elements, e.g., letters in any language, numbers, logos, or purely pictorial designs. Because the most prevalent graphical elements are the letters of the alphabet, graphical elements are generally referred to herein as “letters,” although they may include many different additional shapes. Three dimensional sign letters are formed by preparing a front and back generally in the shape of the letter and attaching side panels, or “returns” as they are called in the trade, that outline the shape of the letter. Because the side panels outline both the inside and outside shape of the letter, a channel is formed and explains why the letters are referred to as “channel letters.” When the returns are assembled with the front and back, they give the sign its three-dimensional characteristic as shown in FIGS. 1A through 1C, described more fully herein. Typically, before the sign is fully assembled, lighting is installed in the channel to illuminate the front or “face” of the letter. To complete the assembly, a “trim cap” or “trim” strip is attached (typically by gluing) to the face. The trim cap generally fits snugly on the outside of the return to assist in keeping the two major components of the sign together—the front panel with attached trim cap and the back panel with an attached return—and to form a seal to prevent moisture and other materials from penetrating into the sign.

Historically, channel letters were prepared by hand using various size templates to cut the front face and the back panel. The back was then measured carefully and laboriously and the measurements and bending instructions for the return were taken from the back and applied for the return material. The rectangular return material was cut to length by hand and then shaped around the back using a press brake. This had to be done for both the outside return on the outside of the letter and for any inside return—required where the letter has a cut-out portion, as shown in the example depicted on FIGS. 1A through 1C. (See, item 20 on FIG. 1A.) The same skill or “art” was required of experienced craftsmen to bend and shape the trim cap and then to install all the components into a finished channel letter.

More recently specialized, programmable equipment has been designed through which a piece of proper sized return material is processed and marked by the machine at appropriate places indicating where the material should be bent or processed to form a return for the appropriately sized letter. Such equipment is described generally in U.S. Pat. Nos. 5,377,516 and 5,456,099, each of which is incorporated by reference as though fully set forth herein. As indicated in those patents, the earliest form of marking encompassed the printing and labeling of instructions at appropriate places on the stock material.

Even more recently specialized, programmable equipment has been designed through which trim cap stock material can be processed and marked by the machine at appropriate places indicating where the stock material should be bent or processed to form the trim cap for an appropriately sized letter. Such Trim Shop™ equipment is available from Arête Corporation, Golden, Colo. and is described generally in U.S. patent application Ser. No. 09/844,954, filed Apr. 26, 2001, for “Method and Apparatus to Prepare Trim Cap Material for Bending.” The contents of that patent application are incorporated by reference as if fully set forth herein.

While these efforts at automation constituted improvements over the time consuming efforts of craftsmen in preparing the back, front, returns and trim cap for a channel letter, they also added considerable expense. A fully automated sign shop would be required to have three separate automated machines to prepare a channel letter: (a) a computerized machine for cutting (i.e., the length) and marking the return stock for bending; (b) a computerized machine for marking the trim stock material to prepare it for bending, and (c) a routing table to cut the back and front of the channel letter. A bend break or press break was also required to bend the return at the indicated places, and a mandrel was usually required to facilitate the forming of arcs by hand until the final shape was achieved.

The steps involved in the prior art automation of preparing the mechanical parts of a channel letter are depicted in the flow diagram shown on FIG. 2A. The process in FIG. 2A begins with the design of a letter of an appropriate shape (i.e., font or script) and size. The design was then translated into computerized artwork from which an output file was prepared. The output file was generally in DXF format. As an overview, this file was then processed in four separate ways: (1) the DXF file was translated to the appropriate format (DXF, HPGL, IGES, etc.) to instruct a router table to cut the shape of the back panel of the letter from a piece of flat sheet stock; (2) the DXF file was translated to the appropriate format (DXF, HPGL, IGES, etc.) to instruct a router table to cut the shape of the front face shape of the letter from a piece of flat sheet stock; (3) the DXF file from the file for cutting the front face of the channel letter was transferred to the computerized trim cap marking machine and further processed to take into account the thickness of the trim cap material and other factors to generate an event queue for applying instructional marking and notching the trim stock material at appropriate places; and (4) the DXF file from the file for cutting the back panel was transferred to the computerized return marking machine and further processed to take into account the thickness of the return material and other factors to generate an event queue for applying instructional marking (i.e., notching) the return stock material at appropriate places. In each instance (i.e., router, trim marker or return marker), the default set-up machine settings were applied to the appropriate file, i.e., (1), (2), (3) or (4). The default settings were then adjusted to produce a modified file for use on the machine as being operated at the time. In the case of the trim marking machine and the return marking machine, rules were also applied to queue events to be marked in the appropriate order as the trim material or return material passed through the machine. Modified files (1) and (2) were then executed by the router to cut the back and front of the channel letter. Modified file (3) was executed by the return marking machine to mark the appropriate places for bending the return material to the appropriate shape. Modified file (4) was executed by the trim cap marker to designate the appropriate places for bending the trim stock to the appropriate shape. The result of these processes (i.e., the marked trim, the marked and cut return, the cut back panel and the cut face) are depicted schematically as points (A), (B), (C) and (D), respectively, in FIG. 2A Obviously, in the case of channel letters such as the “P,” used as an example here, there was more than one marked piece of trim and more than one piece of cut and marked return.

As shown in FIG. 2B, the four major pieces of the channel letter were then assembled in a series of steps. The marked trim cap was then bent, shaped and attached to the front face cut on the router. The marked return material was then bent and shaped using a press break and attached to the back panel with the junction of the two then being sealed and subsequently painted as required. Lighting was then installed inside the channel formed by the return and back plate, all of which were then attached to the appropriate support for the sign or portion of a sign containing the letter. The face and trim cap piece was then installed over the mounted back and return forming the finished letter with illumination. All of these steps were performed laboriously by hand.

Automating the cutting of back and front pieces, along with the marking of the return, and trim cap, improved the efficiency of sign shops and made it possible to produce finished letters of improved quality. For example, the improved fit of the various components produced a more aesthetically pleasing sign with improved durability. However, these advantages were offset by the considerable expense required for of all the necessary equipment. Unless the fully automated sign shop could sell more signs, the increased capacity may not equate to increased profits due to the significant capital cost. In addition, the manufacture of letters still required the skill of experienced craftsmen in interpreting the instructions or markings on the trim cap and return to accurately bend them into appropriate shapes that tightly fit around the front and back portions cut on the router. For these reasons, smaller sign shops could not justify the expense of purchasing automated equipment, and they continued to utilize manual techniques in making channel letters.

Accordingly, a need exists for a process for automating the manufacture of channel letters that minimizes capital costs and provides channel letter parts, i.e., marked return stock, that can be shaped and bent to tightly fit with back and front panels while minimizing the level of skill required of persons doing the assembly work.

### III. BRIEF SUMMARY OF THE INVENTION

The present invention provides a method for forming all major components of a channel letter, i.e., the back, front and returns, on a single piece of manufacturing equipment, i.e., a router table, from a single piece of sheet stock. Among other things, the invention provides a method for an automated router table or other X, Y, Z cutting device to prepare a return that is cut to length, contains markings clearly identifying the location, direction and shape of the bends, and has material removed from the return at appropriate places to facilitate the subsequent bending and shaping of the return without using a press break. The process can be performed on automated routing tables already present in many sign shops or in metal forming facilities that would like to extend their capability to produce channel letter signs.

A more detailed explanation of the invention is provided in the following description and claims, and is illustrated in the accompanying drawings.

### IV. BRIEF DESCRIPTION OF THE DRAWINGS

FIGS. 1A, B and C show a completed channel letter in the shape of a “P.” FIG. 1A shows the front including the trim cap. FIG. 1B shows the side of the letter along view Z-Z. FIG. 1C shows the back of the completed letter including the assembled return.

FIG. 1D is a perspective view of the same letter “P” at one possible intermediate stage of assembly.

FIG. 1E is a view of the letter “P” at an intermediate stage of assembly from a slightly different perspective.

FIG. 1F is a cross-section of the “P” in FIG. 1A at Y-Y and depicts the channel with lighting installed.

FIG. 2A is a schematic diagram showing a typical prior art process for the automated cutting of front face and back panel and the marking of the return and trim cap for subsequent shaping and bending using three separate pieces of equipment. FIG. 2B is a diagram depicting the prior art process of assembling the front face, back panel, return and trim cap prepared according to FIG. 2A.

FIG. 3A is a schematic diagram showing a preferred process of the present invention for the automated cutting of front face and back panel and the marking of the return and trim cap for subsequent shaping and bending. FIG. 3B is a diagram depicting a preferred process of assembling the front face, back panel, return and trim cap prepared according to FIG. 3A.

FIGS. 4A, 4B and 4C depict the returns for the “P” shown in FIG. 1A through 1F. FIG. 4A is a side view of the inside return as prepared on a router in one preferred embodiment of the invention. FIG. 4B is a side view of the outside return as prepared on a router in one preferred embodiment of the invention. FIG. 4C depicts a front view of the inside and outside returns of FIGS. 4A and 4B respectively when shaped, bent and assembled.

FIGS. 4D, 4E, 4F and 4G all depict a common work piece from which the two returns for the “P” are cut and prepared by application of four computer “layers.” FIG. 4G shows the outline of the two returns as they will be cut from the work piece utilizing one of the layers. FIG. 4D shows the application of the scoring for inside bends on the work piece for each of the two returns using another computer “layer.” FIG. 4E shows the application of the scoring for “outside” bends on the work piece for each of the two returns using another computer layer. FIG. 4F shows how the shape of the return is placed on each of the returns on the work piece using another computer layer.

FIG. 5 shows a special cutout for bends in the flange of the return for inward bends more than 100°.

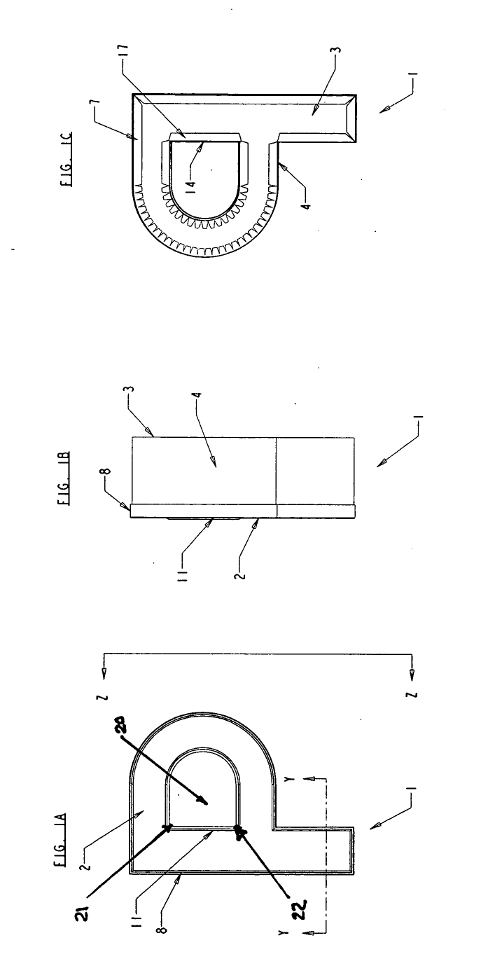

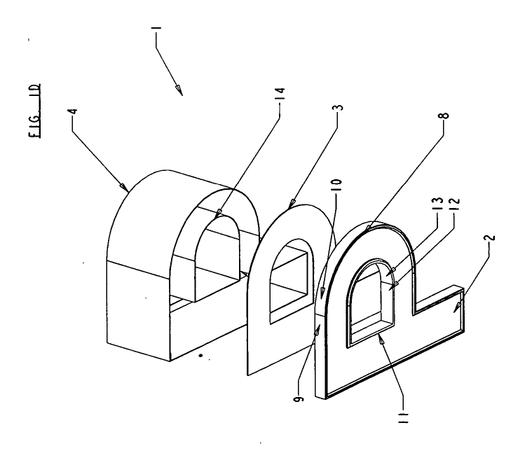

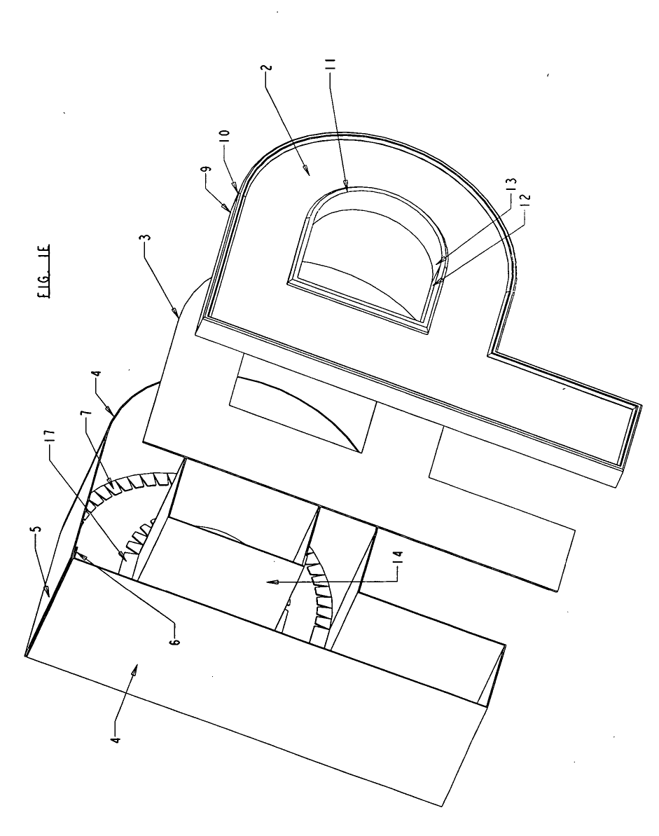

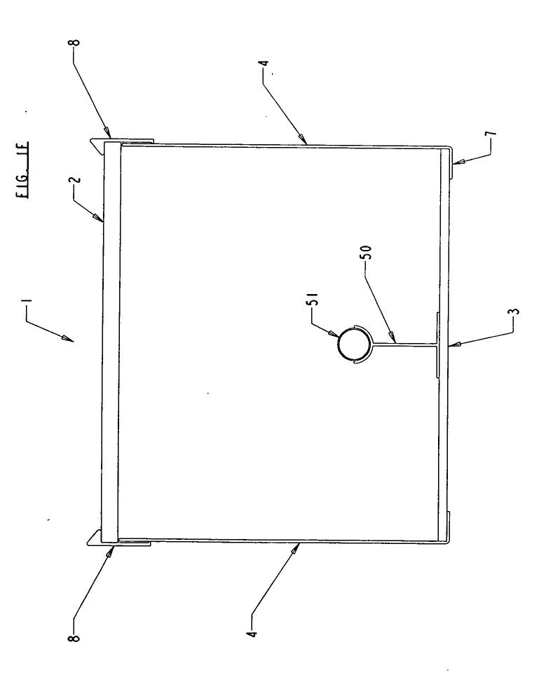

As used herein, an “inside” bend, is any bend on a return corresponding to a portion of a letter where the back (or front) produces a router bit radius. An example of this would be the formation of the return at the corners 21 and 22 on the cut-out portion 20 of the “P” used as the example. (See FIG. 1A.) An “outside” bend is any bend on a return corresponding to a portion of a letter where the back (or front) does not produce a router bit radius.

### V. DETAILED DESCRIPTION OF THE INVENTION AND THE PREFERRED EMBODIMENT

Among other things, the present invention includes a method of preparing a return, including a flange portion on one edge of the return, for subsequent shaping, bending and incorporation into a channel letter comprising cutting the outline of the return in the appropriate length and width from larger sheet stock, the outline including the removal of material from the flange portion of the return indicating where the return is to be shaped and bent, the material being removed in amounts facilitating the shaping and bending depending on the direction and amount of the shape or bend. The width of the return is scored to indicate the location and direction where the return is to be bent in an inward direction and sufficient material is removed from the return to facilitate the subsequent bending of the return in that direction. In addition the width of the return is scored to indicate the location and direction where the return is to be bent in an outward direction and sufficient material is removed from the return during scoring to facilitate the subsequent bending of the return in that direction. The return may also include a depiction of the final, assembled shape of the return.

In accordance with a preferred embodiment of the invention, the returns are prepared using the same machine, e.g., router table, as employed in cutting the back and front of the channel letter, and the returns, back and front are all prepared from the same sheet stock.

The invention also includes an intermediate return having the features evident from this method of preparation.

A preferred embodiment of the present invention is depicted in FIGS. 1 through 5 as described herein.

FIGS. 1A through 1E illustrate the typical construction of a channel letter 1. As illustrated in FIGS. 1A through 1C, the channel letter comprises front face 2 and back panel 3. Return 4 forms the sidewall around the entire outside of the letter 1. Inside return 14 forms the sidewall inside the cut-out portion 20 of the “P.” A “P” is used as an example of a letter having a number of different features, but a “channel letter” could include any two dimensional shape to be depicted three dimensionally in the completed “channel letter.” These four components, i.e., front, back, return and inside return form the essential components of the letter depicted in these figures. If the letter, for example, an “N” has no cut-out portion, there is no inside return, and the letter is essentially formed by the front, back and a single return around the exterior of the letter.

FIGS. 1D and 1E are two perspective views showing the channel letter 1 in typical assembly orientation. FIGS. 1A through 1C illustrate the finished construction of the same channel letter. These drawings show that the outside return 4 has a flange 7 along one edge. The return and flange are part of a single flat sheet of material. Typically, the flange is bent at a right angle to the remainder of the return prior to or otherwise as a part of shaping and bending the return to form the outside shape of the letter. The shaped and bent return in its final form is illustrated in FIGS. 1D and 1E with the ends 5 and 6 of the return being secured in abutting relationship, as shown in FIG. 1D. Similarly, the inside return 14 has a flange 17 along one edge. This flange is also bent at right angles to the remainder of the return. The shaped and bent inside return is shown in its final form in FIGS. 1D and 1E. Typically, the inside return 14 is placed inside the outside return 4 as depicted in these drawings, and the back 3 is positioned inside the outside the return, so that the inside return passes through the cut-out portion of the “P.” FIGS. 1D and 1E illustrate this arrangement just before the alignment of the back panel 3 with the returns. The assembled arrangement of the back and returns is shown best in FIG. 1C. The back and returns are secured to one another, typically by spot welds, pop rivets, clenches, screws or staples. Lighting components are then added to this structure before it is assembled with the front of the letter.

The front of the letter is comprised of the front face 2, an outside trim cap 8 and an inside trim cap 11. The purpose of the trim cap is to enhance the overall appearance of the finished letter and to prevent moisture from entering the letter. The outside trim cap 8 has ends 9 and 10 that are secured in abutting relationship as shown in FIGS. 1D and 1E. The inside trim cap 11 has ends 12 and 13 that are secured in abutting relationship as shown in FIGS. 1D and 1E. Both the inside and outside trim cap are secured to the front face 2. As depicted in FIGS. 1D and 1E, the front face 2 and trim cap 8 and 11 are then secured as a unit to the assembly of back 3 and returns 4 and 14.

FIG. 1F illustrates a cross-section of the letter P along line Y-Y on FIG. 1. The cross-section shows the back panel 3 which is attached to the left and right sides both consisting of the outside return 4 via flange 7. The front face 2 is also depicted along with outside trim cap 8. This drawing shows, in cross-section, neon illumination tubing 51, which is attached to the back 2 via standoff 50. Activation of the neon illuminates the translucent front face 2 with the channel formed by back 3 and outside return 4 acting to reflect the light in the direction of the front face.

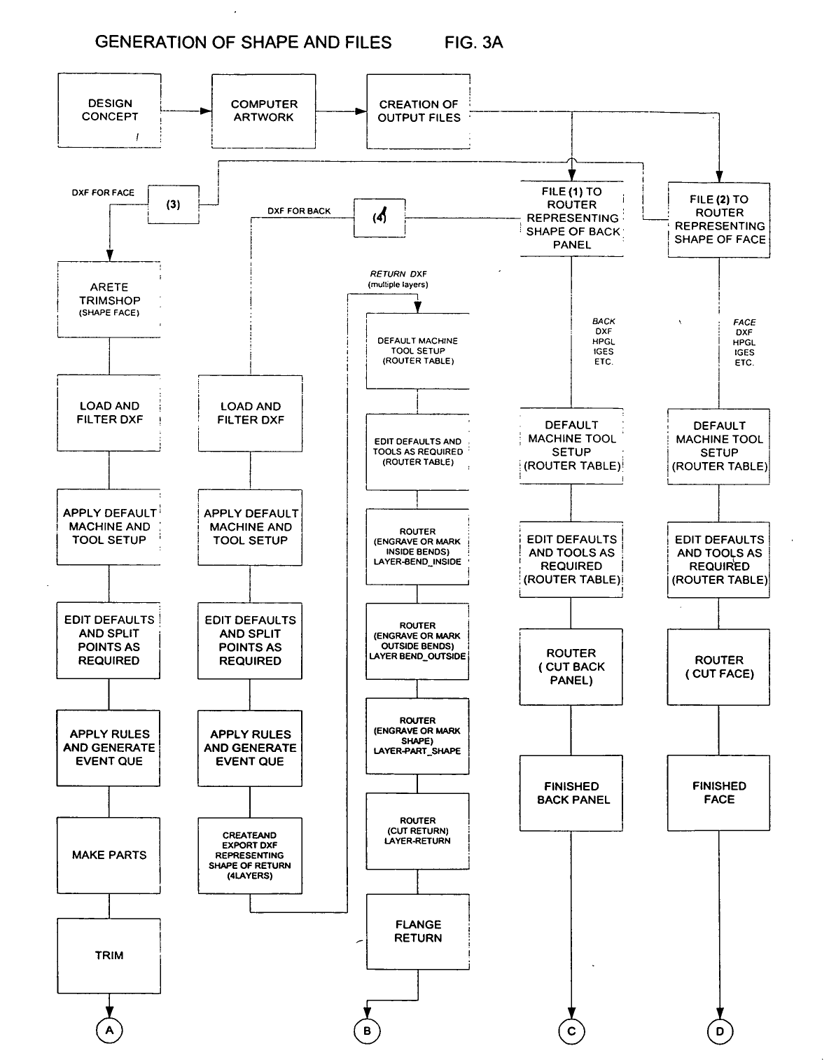

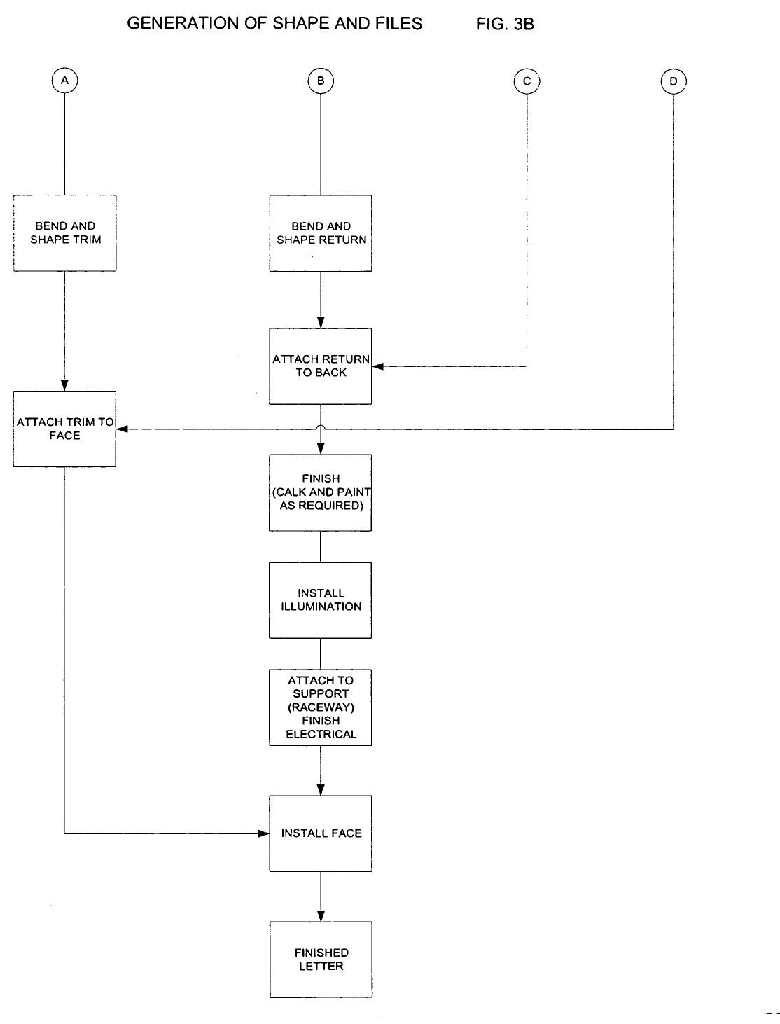

The steps involved in the present invention for integrating the preparation of the mechanical parts of a channel letter are depicted in the flow diagram shown on FIG. 3A. The process in FIG. 3A begins with the design of a letter of an appropriate shape (i.e., font or script) and size. The design is then translated into computerized artwork from which an output file is prepared. In a preferred embodiment, the output file includes the four layers mentioned hereafter for forming the return(s). The output file is generally in DXF or other industry common format. As an overview, this file is then processed in four separate ways: (1) the DXF file is translated to the appropriate format (DXF, HPGL, IGES, etc.) to instruct a router table to cut the shape of the back panel of the letter from a piece of flat sheet stock; (2) the DXF file is translated to the appropriate format (DXF, HPGL, IGES, etc.) to instruct a router table to cut the shape of the front face shape of the letter from a piece of flat sheet stock; (3) the DXF file from the file for cutting the front face of the channel letter is transferred to the computerized trim cap marking machine and further processed to take into account the thickness of the trim cap material and other factors to generate an event queue for applying instructional marking to the trim stock material at appropriate places; and (4′) the DXF file from the file for cutting the back panel is translated into a file that would normally be suited for marking the return and then translated back to drive the router table tools as further described below for cutting and marking return stock material at appropriate places to prepare the return(s). After translation file (4′) would now include queue information for sequencing the execution of the layers used in the formation of the return. Files (1), (2) and (3) are then all executed on a single machine, i.e., the router, to cut the back and front of the channel letter and to cut out, mark and score the return material. File (4) is executed by the trim cap marking machine to designate the appropriate places for bending the trim stock to the appropriate shape and to remove material for accomplishing that task. (See FIG. 3A.)

These parts are then assembled into a finished channel letter, for example, as shown in FIG. 3B. While the back at (C), face at (D) and trim cap at (A) are essentially the same as prepared in the prior art, the returns prepared on the router at (B) are dramatically different. The router not only marks the location of bends, but it removes material along the width of the bend, thereby facilitating the manual bending of the return. In addition, the marking of the shape of the return on the return itself, allows one to readily see the shape of the return for the channel letter involved. Thus, the features of the present invention significantly reduce the level of skill required for assembly, expedite the assembly and eliminate the need for a press break in shaping and bending the return. Thus, cost benefits are achieved in a number of ways and the completed “channel letter” is much tighter and has a more aesthetically pleasing appearance.

As illustrated in FIG. 3A, all of the large pieces of the channel letter, i.e., the back panel, the front face and the returns are all prepared on a single router table obviating the need for a special return marking machine. A shop with a single router table can become an essentially fully automated shop for preparing channel letters. While a trim cap marking machine is desirable and improves efficiency, the trim cap material can be shaped and bent around the face and side of the letter with a minimal amount of required expertise by the assembler, if the other pieces are prepared as described herein. As noted previously, since the returns are prepared from the same stock material as the back and the front, the need for inventorying a variety of differently sized return stock can be avoided.

The routing tables referred to herein are capable of cutting shapes in both the “x” and “y” coordinates. In addition, these tables have the capability for engraving, i.e., they cut the surface of a material in the “z” direction as well. Because engraving requires close tolerance in controlling the depth of the cut, these machines are particularly suited for use in this invention. It is the intention, however, that the invention could be used with any computer-controlled device that is capable of cutting in the x-y-z coordinates.

According to the present invention, the back panel and returns can all be cut from the same piece of sheet stock, for example a sheet of 0.040 inch aluminum, or other materials known to those of ordinary skill in the art. Because the present invention facilitates subsequent shaping and bending of the returns, it is possible to use materials thicker than those ordinarily used in the trade. It may also be possible to use laminates, such as the laminate comprising aluminum and thermoplastic material sold under the trademark “DIBOND” by ATI—Alucobond Technologies, Inc. 77 West Port Plaza Suite 429 St. Louis, Mo. 63146 USA. Translucent materials can be used for the back so that the sign is lighted on both sides. One of the advantages of the present invention is that the sign shop need not maintain a separate inventory of stock material from which backs are cut and of stock material for preparing returns in various widths.

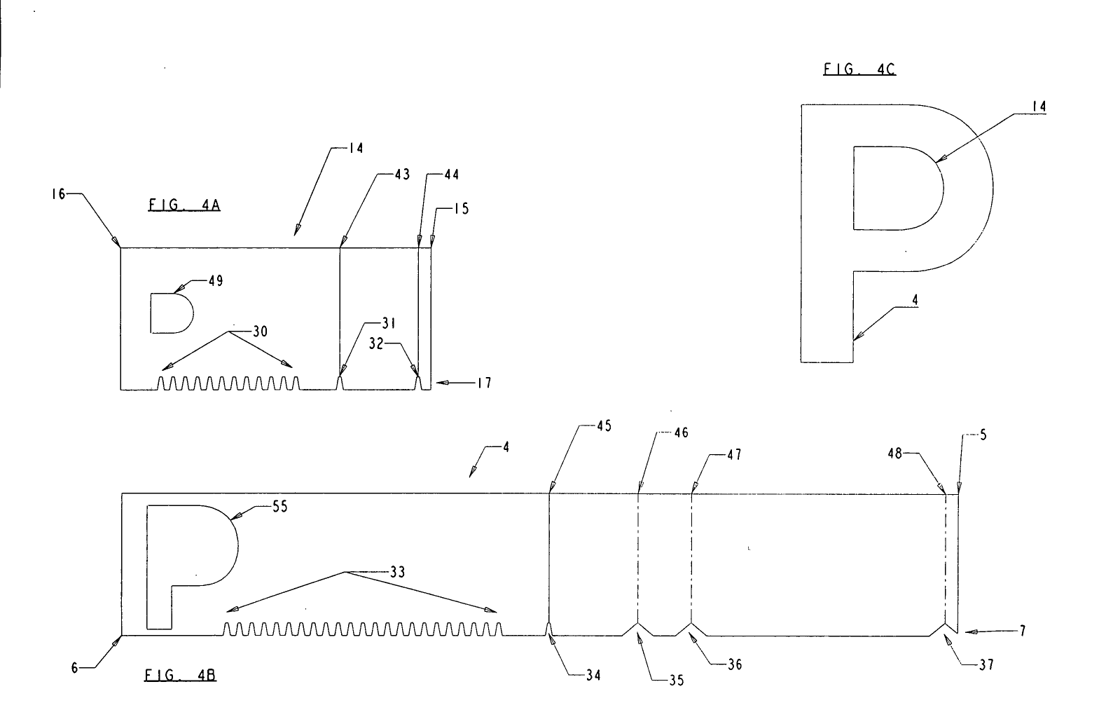

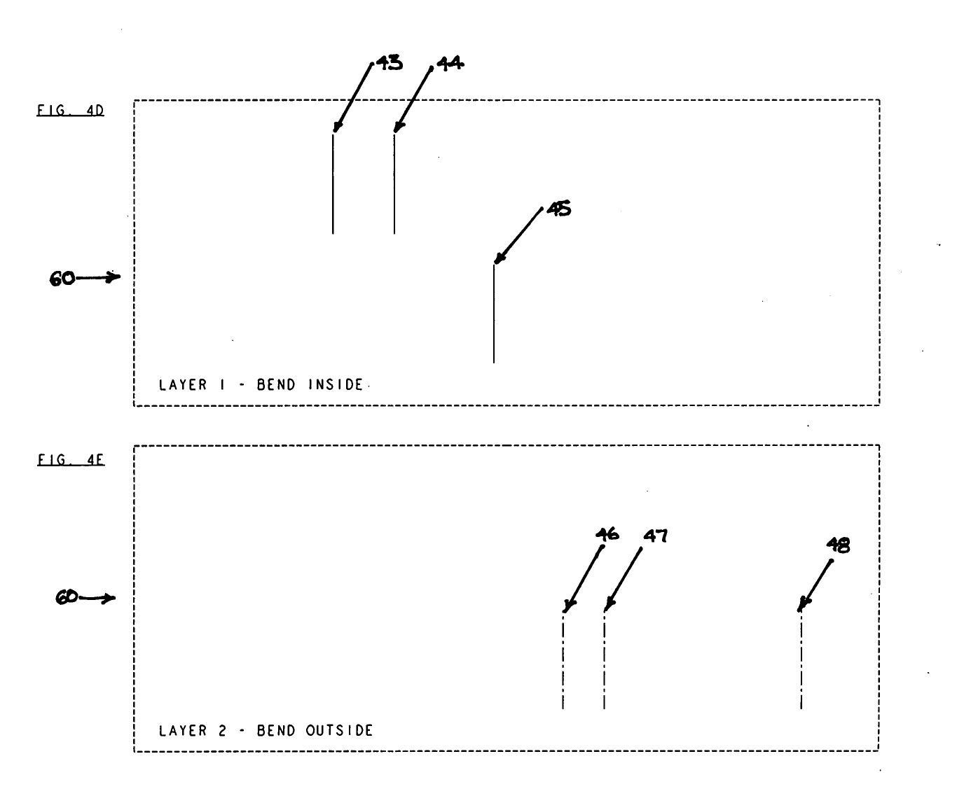

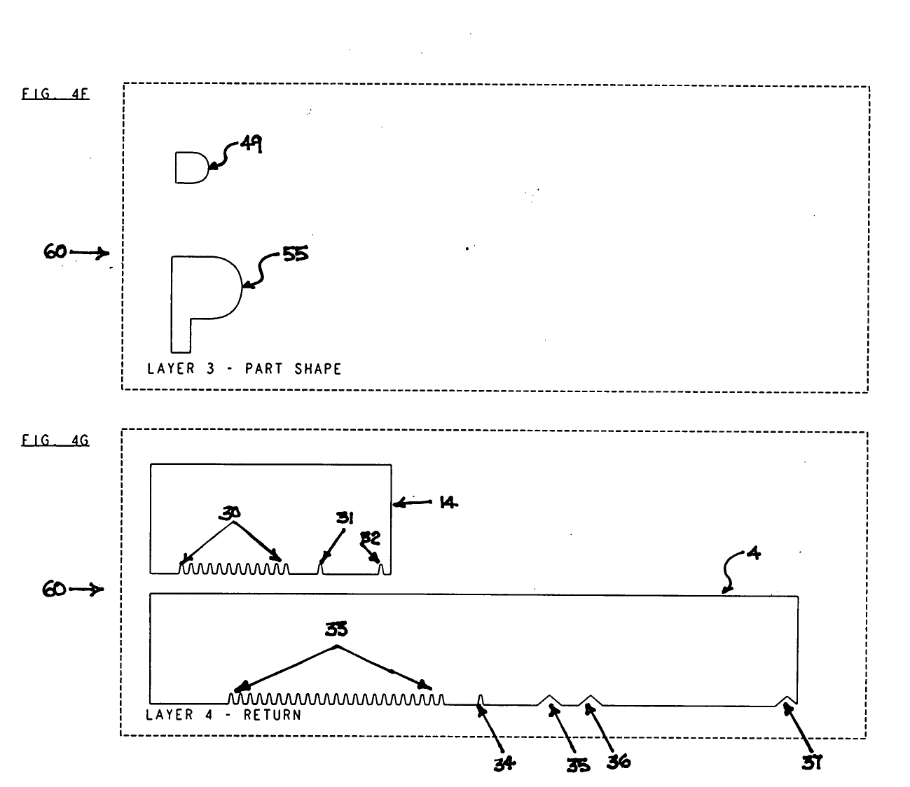

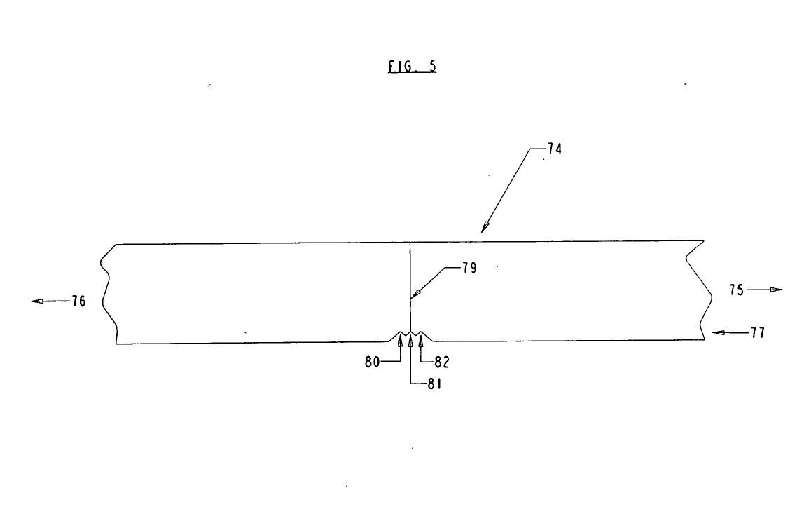

The user specifies the width of the desired return as shown on FIG. 4. The user also specifies the width of the flange that will overlap with the back panel of the channel letter when assembled, also as depicted on FIG. 4. The user also inputs the thickness of the sheet stock material being used to prepare the return along with the router bit size used to cut out the back and the router bit size used to cut the return. Using this information, the method of the present invention can be used to calculate the overall length of the return and will cut it to that length.

An advantage of the present invention is the router table is deployed so that it: (a) marks the return so that the assembler knows where and how to bend the return and (b) removes sufficient material from the return along the score line to facilitate that bending. For example, the router can be programmed so that it: (a) scores the width of the return at different depths to indicate the location and direction of bends, (b) creates notches of various sizes adjacent the scoring to illustrate the shape of the bend and to remove material to facilitate the bend and (c) provides a depiction of the finished shape for each part. This final layer would be drawn on the part with the router or could be referenced utilizing a printout of the routed file. These objectives can be met as follows.

A preferred embodiment of the invention as it relates to the preparation of returns is illustrated in FIGS. 4A through 4C which show the outside return 4 (FIG. 4G) and inside return 14 (FIG. 4A) for the same letter “P” (FIG. 4C) as illustrated in FIGS. 1A through 1F. For convenience, common numerals have been used for common features in all of these drawings. Thus, the outside return 4 has ends 5 and 6 and a flange 7 adjacent the bottom edge of the return. Similarly, the inside return 14 has ends 15 and 16 and a flange adjacent the bottom edge of the return. Where the sheet stock has a finished, i.e., painted surface, the sheet stock should preferably be deployed on the router table with that finished side down, i.e., against the table. Thus all scoring and other marks will appear on the inside of the return and will not be noticed when assembled to form the completed channel letter. The same principle should be applied where unfinished stock material is used. As each of the returns 4 and 14 is depicted in the drawings, the flange will be bent at right angles away from the painted side of the return. These returns are prepared on a router for subsequent shaping, bending and assembly into a finished channel letter. The final shape of the returns arranged concentrically is depicted in FIG. 4C.

The router prepares returns 4 and 14 from a single larger piece of sheet stock in a series of operations generally corresponding to the “layers” mentioned previously. FIGS. 4D through 4G illustrate those operations as embodied on a piece of sheet stock 60 from which the returns 4 and 14 are cut by the router at the locations and to the shapes depicted in FIG. 4G. The cutting operation results in returns of the appropriate lengths and width. It also provides for various shaped notches or cut-outs 31 and 32 on Return 14 and 33, 34, 35, and 36 along the edges to indicate and facilitate the bending, curving or forming of the return into its final required shape. One of the advantages of the present invention is that the router table can produce a variety of these cut-outs appropriate for the ultimate shape of the return. The number and size (i.e., width, depth and shape) of these cut-outs is programmed by (4′) and is only limited by the radius of the routing tool being used to create them. This flexibility is not available from return markers currently used in the trade. It contributes significantly to the ease by which the cut return material can be formed into the desired shape.

FIGS. 4D and 4E illustrate the features of two additional layers in the formation of the returns. FIG. 4D shows the creation of score marks for “inside” bends and FIG. 4E shows the creation of score marks for “outside” bends, as defined previously. On FIG. 4D, score marks 43 and 44 are formed on the sheet stock at the appropriate location corresponding to the finished return 14 and score mark 45 is formed on the sheet stock at the appropriate location corresponding to the finished return 4. The scoring extends across the width of each return to indicate the location of the bend and sufficient material is removed to facilitate the making of the bend. The inside direction of the bend is further indicated by corresponding narrow notches 31, 32 and 34.

Similarly, on FIG. 4E, score marks 46, 47 and 48 are made along the width of the sheet stock corresponding to return 4 to indicate the location of outside bends. Again, sufficient material is removed during the scoring process to facilitate the making of the bend. The direction of the bend is further indicated by the corresponding wide notches 35,36 and 37. Since there are no outside bends on return 14, no scoring appears on the sheet stock at the location corresponding to FIG. 4E.

Finally, FIG. 4F illustrates the depiction of the return shape on each of the respective returns. Thus, the shape 49 of the completed return 14 corresponding to the cutout portion 20 of the “P” is engraved or cut to an appropriate depth or otherwise marked in the area of the sheet stock corresponding to the return 14. The shape 55 of the completed return 4 corresponding to the outside perimeter of the letter “P” is engraved or cut to an appropriate depth or otherwise marked in the area of the sheet material corresponding to the return 4. These shapes 49 and 55 enable the assembler to visually perceive the shape in which the return needs to be manipulated to complete its configuration.

Thus, the combination of notches, scoring marks and assembly shapes makes it easy for one to prepare the finished returns. Various combinations of two or more of these features can be employed to facilitate that process depending on the sheet material being employed, the skill of the assembly person and the nature of the shape being formed.

The order of performing the operations depicted on FIGS. 4D through 4G is not particularly important. However, when all of the operations are performed (as can be seen by overlaying these four drawings), the result will be the returns 14 and 4 as depicted in FIGS. 4A and 4B, respectively.

With reference to FIG. 4A, the router cuts the outline of the shape of the return 14 including the specified width and the calculated length of the return. In proceeding to cut this outline, the router tool also cuts various shapes in the flange area 7 designating the location and facilitating the subsequent processing of the return into the required shapes and bends. In this case, the router has cut a series of 30° notches corresponding to the location where the inside return 14 will form the curved portion of the sidewall in the cut-out portion of the “P.” The cutting of this material from the return enables the return and the flange of the return to be formed into the curve without buckling or interference of the material in the flange. This is illustrated, for example, in FIG. 1C. Similarly 30° notches 31 and 32 are formed in the flange where the return will be bent away from the flange. The return is completed by using the engraving tool to score the width of the return along lines 43 and 44 where the return will be bent. The scoring provides information regarding the location of the bends and removes an appropriate amount of material from the surface of the return so that the bending is facilitated.

Similarly, the outline of return 4 is also cut from a larger piece of sheet stock, e.g., 60. Where possible, returns 4 and 14 will be cut sequentially from the same sheet of sheet stock as it is laid on the router table. In cutting the outline of return 4, the router again cuts out a series of 30° degree cuts 33 where the return will be curved at the appropriate portion of the “P” shape. A 30° degree cut is also made where the return will be bent to transition from the curve to the leg of the “P.” Again, this is performed to indicate the location of the bend and to facilitate the making of the bend outward from the flange. Finally, the outline of the return 4 is formed with 100° degree cuts 35, 36 and 37 in the flange area. These cuts are larger than cuts 31, 32 and 34, both to indicate that the direction of the bend is toward the flange, and to compensate for the greater propensity for the flange to buckle when that bend is made.

In addition to cutting the outline of the return from the sheet stock the router also engraves line 45 where there will be a bend. In a final operation, the router engraves lines 46, 47 and 48 where there will be bends. Again, the purpose of the engraved line is to indicate the location and direction of the bend and to remove an appropriate amount of material from the surface of the return to facilitate the making of the bend in the direction indicated.

In indicating the location of bends, it is desirable that the return be scored to different depths to indicate to the assembler which direction the bend should be made, i.e., toward or away from the scoring. For example, where the scoring indicates that the bend should be made in the direction of the scoring, the scoring should be deeper than when the scoring indicates that the bend is away from that mark. For example, where 0.040 inch aluminum stock is used, the depth of scoring for bends away from the score mark could be 0.010 inch, while scoring indicating that the bend is toward the score mark could be 0.020 inch. Scoring, however, should never be more than half the thickness of the material to avoid weakening it unnecessarily. Using this example, lines 43, 44, and 45 on the returns shown in FIG. 4A and FIG. 4B would be scored to a depth of 0.010 inch and lines 46, 47, and 48 would be scored to a depth of 0.020 inch. An assembler with a modicum of experience would easily be able to look at the return and determine where to make bends by the scoring marks and in which direction to make the bend by the depth of the scoring. The increased depth of the scoring marks also removes material from the bend facilitating bends in the direction toward the scoring. Thus, proper sizing of the scoring may eliminate the need for using a hand break to bend the return. Additionally the part shape 49 can be printed or scored to a minimum depth directly on the return detailing the finished shape of the part after cutting (routing) and bending.

There are other ways of designating the bending direction and facilitating the bending that might be used in conjunction with or as an alternative to scoring at different depths. For example bends away from the mark could be scored with dashes, dots or other intermittent lines, while scoring for bends toward the mark could be scored completely. Alternatively, the scoring for bends toward the mark could be made with very close parallel score lines made by multiple passes of the engraving tool, while bends away from the mark could use a single line of the same depth. Other alternatives would be known to one of ordinary skill in the art.

Similarly, the router can be used to form various sized notches in the return in the area where the flange will be formed. The size and nature of those notches will also provide information about the location and type of bending relative to the flange and will remove material to facilitate the bending. For example, the router could be employed to cut two sizes of notches of 30° and 100° as illustrated in FIG. 4. The notch depth, spacing and profile are controlled by the setup. A single 30° notch adjacent scoring would be used where the bend will be less than 30° inward or is an outward bend. A single 100° notch adjacent scoring would be used where the bend is an inward bend of greater than 30° and less than 100°. A series of three 100° overlapping notches are used where the bend is toward the scoring and the bend is more than 100 degrees (as in the case of the return for the upper right corner of an “X” shaped letter). This is shown, for example, in FIG. 5, depicting a portion of a return having ends 75 and 76. Score mark 79 indicates the location of an inward bend and has sufficient material removed to accommodate the formation of an acute angle in the bent return. Three overlapping 100° notches with peaks at 80, 81 and 82 are cutout of the flange area to accommodate this bend.

A long series of 30° degree notches can be employed where there is a gentle bend as, for example, along the sides of an “S” shaped letter.

An advantage of the present invention over the prior art is that the router table is much more flexible in creating indicia for bending and facilitating the bending by the removal of the material. Router bits in various sizes can be employed to meet these objectives depending on the thickness of the stock material employed. While notches of two different sizes are illustrated on FIG. 4, other profiles for material removal can be employed to meet the objectives set forth above. For example, in addition to or as an alternative, different shaped notches might be used. For example, a gentle curve toward the flange side might be indicated by a series of 15° notches, a hard curve might have a series of 60° notches. Curves away from the flange side might have only a slit with no angle at all (since the notch will be opened when the material is shaped or bent. Also, instead of using three overlapping 100° degree notches to indicate a bend toward the scoring of more than 100°, a single large notch of the correct size could be used. The important thing is that the router table is employed to provide indicia of the location and shape of curves and bends and that material be removed from the return sufficient to facilitate that shaping and bending. Numerous ways of implementing those principles known to one skilled in the art could be employed to achieve that objective.

While the foregoing discussion has been directed to an example of a routing machine having the capability of cutting in the x-y-z coordinates, the device might have additional tools to achieve the objectives of this invention. For example, the router might also have a writing or marking utensil, e.g., a felt tip marker or laser at a reduced power level. This could be used to add written information to the return, such as the identity and contact information for the manufacturer, and additional information such as the date, time, setup parameters, customer identification, identity of the part, etc. The writing utensil could also be used to indicate the location and shape of curves and bends and to provide the depiction of the assembled return (e.g., 61 and 55) on the return.

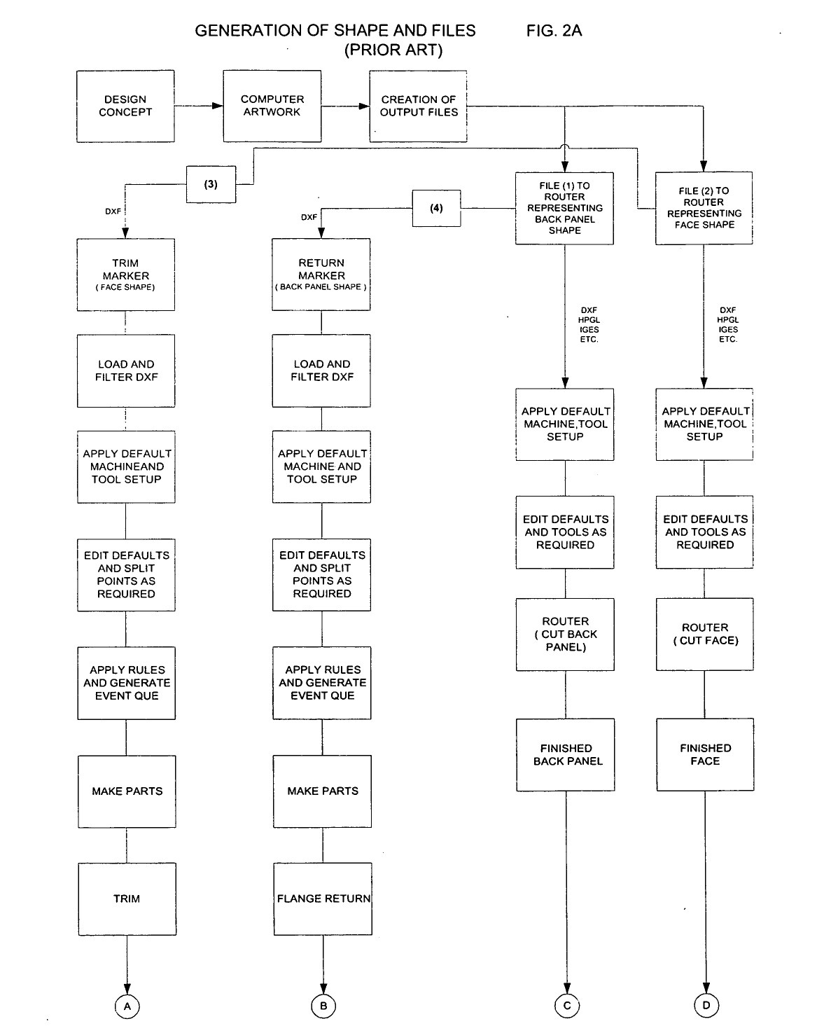

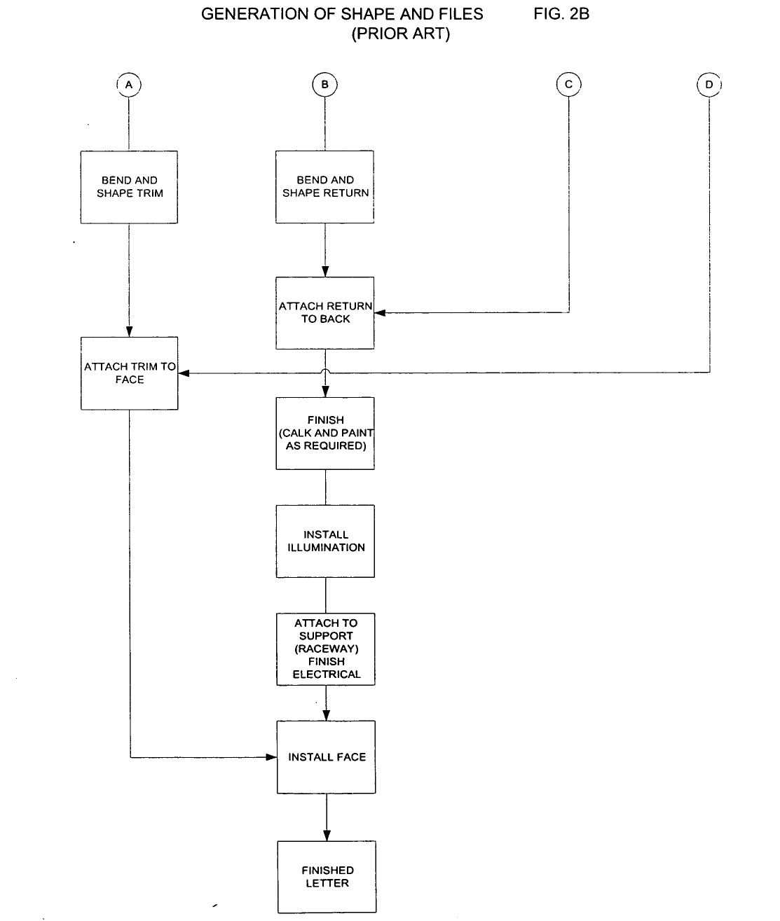

As shown on FIG. 2A, the router is directed by software that converts the file shape of the letter into the appropriate directions for cutting the front, back and returns for that shape. The logic for converting the shape into the directions is known to those skilled in the art and takes into account the thickness of the material being worked upon, the size of the router bit and other similar parameters, which are input by the user. The software can be operated on a computer associated with the router table or on a separate computer or at an application service provider (“ASP”) with the directions being delivered from the computer or ASP to the router table. The software can be contained on computer readable media such as a CD, disk, or computer memory of any of the various types available. The router table will, of course, contain its own software for directing the tools, for efficiently locating the pieces to be cut on the sheet stock placed on the table and for efficiently sequencing the tool operations.

As noted previously, the directions for preparing the return are best delivered in four layers for cutting the outline of the return, scoring bends inward, scoring outward bends and indicating the finished shape of the return. These steps can be performed in any sequence by the router. Additional layers, such as one for a marking utensil, can also be employed. The number and sequence of layers will depend upon the tooling employed to practice the principles of this invention and the sequence can be governed by matters of efficiency.

While a preferred embodiment of the invention has been described herein, it should be apparent to one skilled in the art that other embodiments may be included within the scope of the following claims. Accordingly, the claims should not be limited to the particular embodiments described and depicted.

1. A method of preparing a return intermediate, including a flange portion on at least one edge of the return, for subsequent shaping, bending and incorporation into the return for a channel letter comprising:
cutting the outline of the return in the appropriate length and width from larger sheet stock, said outline including the removal of material from the flange portion of the return indicating where the return is to be shaped and bent, said material being removed in amounts facilitating the shaping and bending depending on the direction and amount of the shape or bend;
scoring the width of the return to indicate the location and direction where the return is to be bent in an inward direction and removing material from the return to facilitate the subsequent bending of the return in that direction; and
scoring the width of the return to indicate the location and direction where the return is to be bent in an outward direction and removing material from the return to facilitate the subsequent bending of the return in that direction.

2. The method of claim 1 wherein the scoring of the return for bends in the inward direction is different from the scoring of the return for bends in the outward direction.

3. The method of claim 2 wherein the scoring of the return for bends in the inward direction is deeper than the scoring of the return for bends in the outward direction.

4. The method of claim 1 wherein all of the cutting and scoring are all performed by a router.

5. The method of claim 1 wherein at least one of the scoring steps is performed before cutting the outline.

6. The method of claim 1 wherein the cutting and scoring result in the removal of sufficient material from the return so that it can be subsequently shaped and bent without a hand brake.

7. The method of claim 1 which further includes the marking the return with the shape of the finished return.

8. A method for preparing a back panel and a return intermediate, including a flange portion on at least one edge of the return, for subsequent shaping, bending and incorporation into a channel letter comprising:
cutting the outline of the back panel and the return from a single piece of larger sheet stock said outline including the removal of material from the flange portion of the return indicating where the return is to be shaped and bent, said material being removed in amounts facilitating the shaping and bending depending on the direction and amount of the shape or bend;
scoring the width of the return to indicate the location and direction where the return is to be bent in an inward direction and removing material from the return to facilitate the subsequent bending of the return in that direction; and
scoring the width of the return to indicate the location and direction where the return is to be bent in an outward direction and removing material from the return to facilitate the subsequent bending of the return in that direction.

9. The method of claim 8 wherein the scoring of the return for bends in the inward direction is different from the scoring of the return for bends in the outward direction.

10. The method of claim 9 wherein the scoring of the return for bends in the inward direction is deeper than the scoring of the return for bends in the outward direction.

11. The method of claim 8 wherein all of the cutting and scoring are all performed by a router.

12. The method of claim 8 wherein at least one of the scoring steps is performed before cutting the outline.

13. The method of claim 8 wherein the cutting and scoring result in the removal of sufficient material from the return so that it can be subsequently shaped and bent without a hand brake.

14. The method of claim 8 which further includes the marking the return with the shape of the finished return.

15. A return intermediate, including a flange portion on at least one edge of the return, for subsequent shaping, bending and incorporation into a channel letter comprising:
a return outline in the appropriate length and width said outline in the flange portion including areas where material has been removed indicating where the return is to be shaped and bent and in amount facilitating the shaping and bending depending on the direction and amount of the shape or bend;
scoring across the width of the return to indicate the location and direction where the return is to be bent in an inward direction, said scoring being in an amount to facilitate the subsequent bending of the return in that direction; and
scoring across the width of the return to indicate the location and direction where the return is to be bent in an outward direction, said scoring being in an amount to and facilitate the subsequent bending of the return in that direction.

16. The return intermediate of claim 15 which further includes marking depicting the shape of the finished return.

17. A computer program storage medium readable by a computing system and encoding a computer program for executing a computer process for directing a machine to prepare a return, including a flange portion on at least one edge of the return, for subsequent shaping, bending and incorporation into a channel letter comprising:
cutting the outline of the return in the appropriate length and width from larger sheet stock, said outline including the removal of material from the flange portion of the return indicating where the return is to be shaped and bent, said material being removed in amounts facilitating the shaping and bending depending on the direction and amount of the shape or bend;
scoring the width of the return to indicate the location and direction where the return is to be bent in an inward direction and removing material from the return to facilitate the subsequent bending of the return in that direction; and
scoring the width of the return to indicate the location and direction where the return is to be bent in an outward direction and removing material from the return to facilitate the subsequent bending of the return in that direction.
